(19) United States
(12) Patent Application Publication
(10) Pub. No.: US 2026/0026657 A1
(43) Pub. Date: Jan. 29, 2026

(54) Multi-axial Turbulence Induction Container

(71) Applicant: OXIRZE LLC, Cedar Park, TX (US)

(72) Inventor: Raveen Telugu, Cedar Park, TX (US)

(73) Assignee: OXIRZE LLC, Cedar Park, TX (US)

(21) Appl. No.: 19/313,348

(22) Filed: Aug. 28, 2025

Related U.S. Application Data
(63) Continuation-in-part of application No. 29/953,944, filed on Jul. 24, 2024.
(60) Provisional application No. 63/688,548, filed on Aug. 29, 2024.

(30) Foreign Application Priority Data
Jan. 22, 2025 (WO) WIPO158516

(51) Int. Cl. A47J 43/27

(52) U.S. Cl. CPC A47J 43/27

(57) ABSTRACT

Apparatus and related methods relate to a multi-axial turbulence inducing container. In an illustrative embodiment, a container may include a vessel extending along a longitudinal axis. The vessel may, for example, include an interior volume defined by an interior wall. The interior wall may, for example, include a geometry with a series of polyangular cross sections orthogonal to the longitudinal axis. A largest polyangular cross section may, for example, be positioned between the opening and the terminal end. The interior wall's curvature may, for example, include a first inflection point before and a second inflection point after the largest polyangular cross section. Adjacent polyangular cross sections may, for example, be rotated relative to each other along a helical path. Various embodiments may advantageously mix additives into a fluid by shaking while maintaining a smooth and easy-to-clean interior geometry.

### CROSS-REFERENCE TO RELATED APPLICATIONS

This application claims the benefit of U.S. Provisional Patent Application Ser. No. 63/688,548, titled “Multi-Axial Turbulence Induction Container”, filed by Telugu on Aug. 29, 2024.

This application is a continuation-in-part of and claims the benefit of U.S. Design Pat. application Ser. No. 29/953,944, titled “Beverage Container”, filed by Telugu, et. al. on Aug. 29, 2024; and of International Design Registration DM/245351, titled “Beverage Bottle”, filed by Telugu, et al., on Jan. 22, 2025, which claims priority to the Ser. No. 29/953,944 application.

This application incorporates the entire contents of the foregoing applications herein by reference.

Unless expressly stated, changes in terminology from priority application(s) to this application are made without prejudice or disclaimer of subject matter. Changes from the priority application(s) (e.g., provisional applications(s)) are intended to be broadening and/or additive unless expressly stated otherwise. Replacement of alternative terms with a single representative term, for example, are inclusive unless otherwise defined. Various embodiments may also be found in previous disclosure(s) incorporated by reference. Embodiments of similar languages in this application are not modifications or disclaimer of the embodiments disclosed in previous incorporated disclosures unless otherwise stated.

### TECHNICAL FIELD

Various embodiments relate generally to shakers.

### BACKGROUND

Shakers, including protein shakers, may, for example, include versatile, portable containers designed for mixing various powders and liquids. Protein shakers, such as with tight-sealing lids and/or built-in mixing mechanisms like wire whisks or grids may, for example, be used by fitness enthusiasts for creating smooth, clump-free drinks on the go. Shakers may, for example, be used for blending meal replacement shakes, pre-workout supplements, and/or cocktails, and may be considered important tools for those seeking convenience and/or efficiency in their nutrition and/or lifestyle routines.

### SUMMARY

Apparatus and related methods relate to a multi-axial turbulence inducing container. In an illustrative embodiment, a container may include a vessel extending along a longitudinal axis. The vessel may, for example, include an interior volume defined by an interior wall. The interior wall may, for example, include a geometry with a series of polyangular cross sections orthogonal to the longitudinal axis. A largest polyangular cross section may, for example, be positioned between the opening and the terminal end. The interior wall's curvature may, for example, include a first inflection point before and a second inflection point after the largest polyangular cross section. Adjacent polyangular cross sections may, for example, be rotated relative to each other along a helical path. Various embodiments may advantageously mix additives into a fluid by shaking while maintaining a smooth and easy-to-clean interior geometry.

The details of various embodiments are set forth in the accompanying drawings and the description below. Other features and advantages will be apparent from the description and drawings, and from the claims.

### BRIEF DESCRIPTION OF THE DRAWINGS

FIG. 1A depicts an example multi-axial turbulence induction container employed in an illustrative use-case scenario.

FIG. 1B depicts a longitudinal cross-section of the container of FIG. 1A.

FIG. 1C depicts an illustrative profile of a wall of the container of FIG. 1A relative to the longitudinal axis.

FIG. 1D depicts illustrative cross-sections of the container of FIG. 1A.

FIG. 2A depicts an example multi-axial turbulence induction container.

FIG. 2B depicts an example multi-axial turbulence induction cap.

FIG. 3A depicts an example multi-axial turbulence induction container and inner wall.

FIG. 3B depicts an example multi-axial turbulence induction container cross-section.

FIG. 4A, FIG. 4B, and FIG. 4C depict an example cap in a closed mode, unlatched mode, and open mode, respectively.

FIG. 5 depicts an example illustrative use-case scenario including a hinge of an exemplary multi-axial turbulence induction container lid.

FIG. 6 is a flowchart illustrating a method for inducing multi-axial turbulence within a vessel.

Appendix A depicts some exemplary drawings of an exemplary multi-axial turbulence induction container.

Appendix B depicts an exemplary use-case of the multi-axial turbulence induction container.

Appendix C depicts some exemplary multi-turbulence induction container embodiments, and exemplary markings of structural features.

Appendix D depicts some exemplary multi-turbulence induction container embodiments.

Appendix E depict some exemplary multi-turbulence induction container schematics and embodiments.

Like reference symbols in the various drawings indicate like elements.

### DETAILED DESCRIPTION OF ILLUSTRATIVE EMBODIMENTS

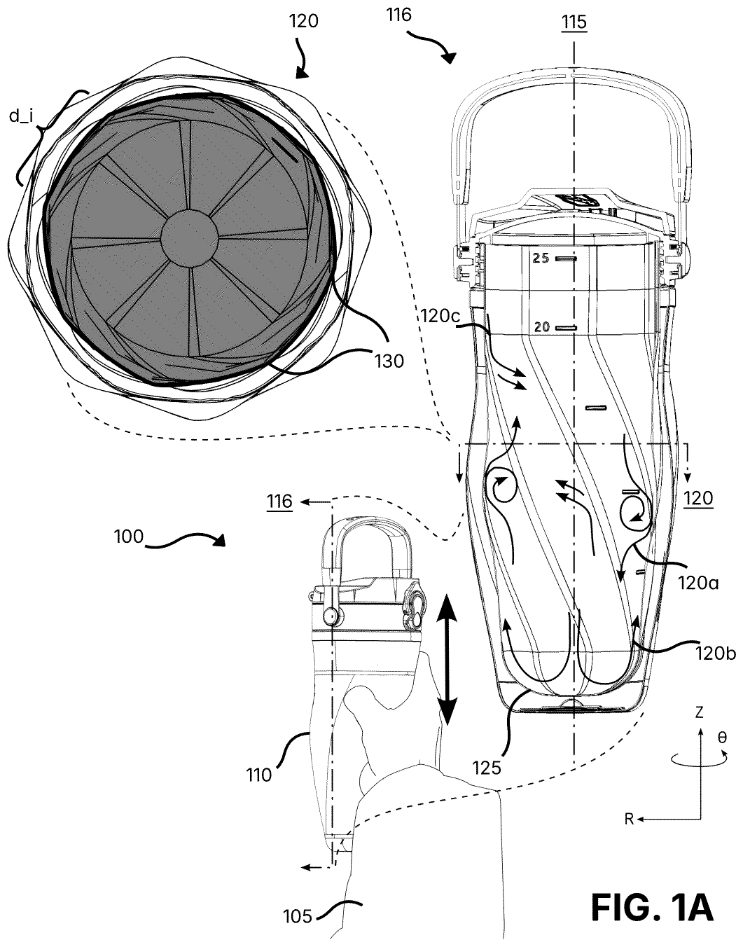

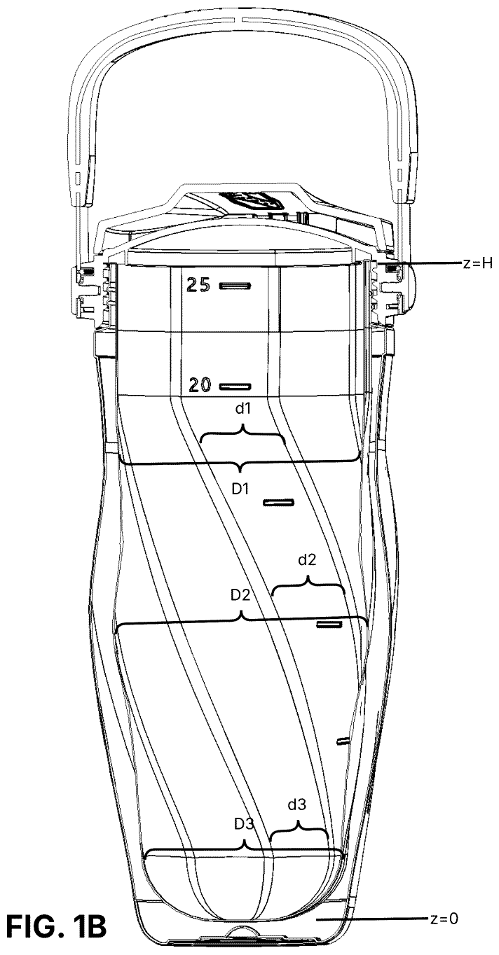

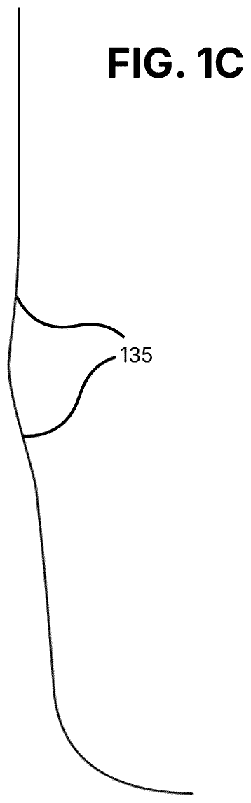

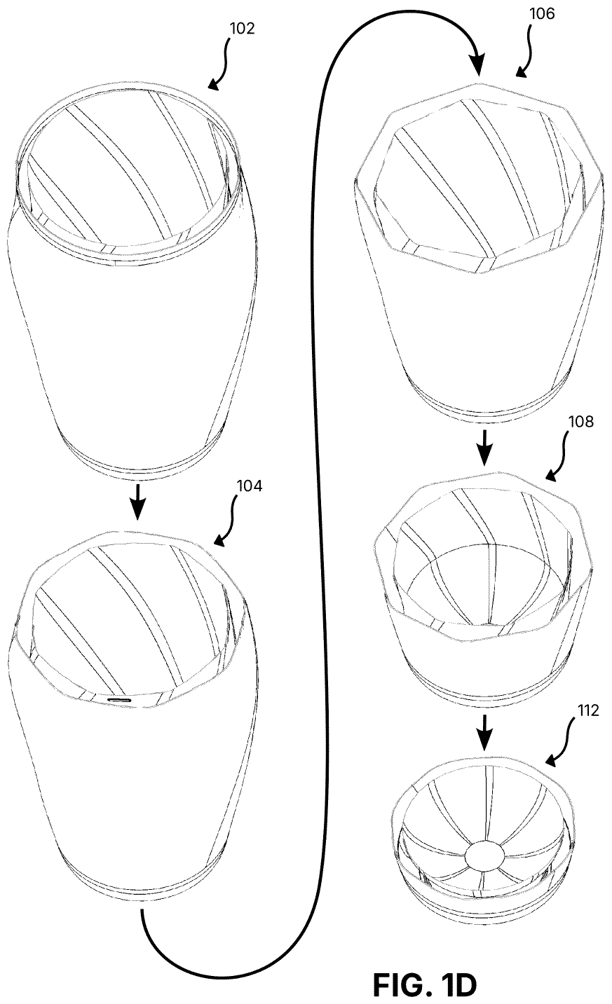

To aid understanding, this document is organized as follows. First, to help introduce discussion of various embodiments, an exemplary multi-turbulence container and lid is introduced with reference to FIGS. 1-6. Second, that introduction leads into a description with reference to Appendixes A-E of some exemplary schematics and embodiments of the multi-turbulence induction container.

FIG. 1A depicts an exemplary multi-axial turbulence induction container employed in an illustrative use-case scenario 100. The illustrative use-case scenario 100 includes a user 105. The user 105 is shaking a multi-axial turbulence induction container 110. The multi-axial turbulence induction container is being shook along a (e.g., predetermined) longitudinal axis 115.

The multi-axial turbulence induction container 110 includes a series of polyangular transverse cross-sections 120. Fluid may, for example, be disposed within the container in this illustrative use-case scenario. The fluid may, for example, include water. Powder may, for example, be disposed in the container in this illustrative use-case scenario. The powder may, for example, include protein powder.

In this example, as shown in longitudinal cross-section 116, the multi-axial turbulence induction container 110 includes a curved bottom 125. The curved bottom may, for example, advantageously induce fluid to flow upward and/or outward as the bottle is shaken up and down.

As shown in FIG. 1B, the multi-axial turbulence induction container 110 may, for example, include a varying diameter and/or inter-angle distance geometric relationship. The effective diameters (e.g., max distance from longitudinal axis 115 to perimeter of cross-sectional area) may, for example, vary from a proximal end (e.g., at an aperture of the lid) to a distal end (e.g., at the bottom of the container).

As shown in this example, the largest diameter may, for example, be between the initial diameter and terminal diameter. The initial diameter may, for example, be larger than the terminal diameter. The multi-axial turbulence induction container may, for example, include an interior set of cross sections. The cross sectional area (A1, A2, A3) corresponding to the corresponding effective diameters (D1, D2, D3) may, for example, vary as a function of a distance Z along the longitudinal axis 115.

An inter-angle distance d_i (e.g., a ‘facet’ length/segment length) of the boundary of the transverse cross-section 120 may, for example, vary in relation to a distance Z along the longitudinal axis 115. For example, the distance d_i (e.g., d1, d2, d3) may vary proportionally to the effective diameter (D1, D2, D3). For example, d2 may be larger than d1 and d3. For example, d2 may be larger than d1.

The polyangular cross sections 120 may, for example, induce rotational turbulence 120c in the container. For example, the angles 130 may follow, as shown, a helical path relative to the longitudinal axis 115. Accordingly, adjacent cross-sections may be rotated in relation to each other about the longitudinal axis 115.

Segments between angles 130 of the cross-section boundary may, as depicted, be convex relative to the longitudinal axis 115. This may, for example, contribute to inducing the rotational turbulence 120c.

The varying cross-sectional area (e.g., effective diameter) of the polyangular transverse cross-section 120 may, for example, induce radial turbulence 120a. For example, as diameter increases approaching the largest polyangular cross-section 106, and then decreases again after the largest polyangular cross-section 106, the change in cross-sectional area may advantageously induce radial turbulence 120a. For example, fluid moving in the longitudinal direction may move outward as pressure drops as the cross-sectional area expands, then be forced radially inwards as the cross-sectional area shrinks. The radial turbulence 120a may, for example, advantageously mix the contents of the container 110.

As shown in this example, the largest polyangular cross-section 106 may be positioned in a middle portion of the container 110 along the longitudinal axis 115. For example, positioning the largest polyangular cross-section 106 in a middle portion may allow time for fluid to accelerate before inducing the radial turbulence 120a. This may, for example, advantageously increase a mixing effect induced by the ‘bulge’ in the cross-sectional area. For example, the largest polyangular cross-section 106 may be in a center half lengthwise. In some examples, the largest polyangular cross-section 106 may be in a center third lengthwise.

In some embodiments, the largest polyangular cross-section 106 may be a local maxima. For example, in some embodiments, an end aperture may be equal to or larger than the largest polyangular cross-section 106. In some such embodiments, the end aperture may, for example, be effectively shrunk (e.g., back below the largest polyangular cross-section 106) when a lid is attached.

FIG. 1C depicts an illustrative profile of a wall of the container 110 relative to the longitudinal axis 115. The profile includes a curvature exhibiting inflection points 135. An inflection point 135, in mathematical terms, may, for example, be a point on a curve where the curvature changes sign, indicating a transition from concave to convex or vice versa. In the context of the container 110, the first inflection point may, for example, occur before the largest polyangular cross-section 106, as shown in FIG. 1C. This first inflection point may, for example, mark the transition from an inward curvature to an outward curvature along the interior wall. The second inflection point may, for example, occur after the largest polyangular cross-section 106. This second inflection point may, for example, indicate a transition back to an inward curvature. These inflection points may, for example, contribute to the multi-axial turbulence by facilitating changes in fluid flow direction within the container 110.

The curved bottom 125 may, for example, induce axial turbulence 120b. The axial turbulence 120b may accompany radial displacement. For example, as the container 110 is shaken up and down along the axis 115, the curved bottom end may reverse the flow of the fluid and urge the fluid radially outward against the inner wall. This flow may, for example, advantageously rapidly accelerate fluid flow and/or resist formation of flow ‘strata’ about the longitudinal axis.

Accordingly, various embodiments may advantageously mix fluid in the container 110 by multi-axial turbulence. For example, radial turbulence 120a, axial turbulence 120b, and/or rotational turbulence 120c may advantageously induce mixing in multiple axes (e.g., axial, radial, and/or rotational). Some embodiments may, for example, advantageously efficiently and/or thoroughly mix contents of the container 110 without protrusions into the inner volume of the container 110. The reduction or omission of protrusions may, for example, advantageously increase sanitation, increase cleanability, and/or reduce parts (e.g., cost, manufacturing difficulty).

FIG. 1D shows a series of cross-sectional views of a multi-axial turbulence induction container. The opening cross-section 102 is depicted at the top of the container. This section may, for example, facilitate the introduction of contents into the container 110. In some embodiments, the inside cap design may, for example, be polygonal. The polygon may, for example, include an octagon. The polygon may, for example, include a hexagon. The polygon may, for example, include a pentagon. In this example, the opening cross-section is circular.

Below the opening cross-section 102, a first polyangular cross-section 104 is shown. This section may, for example, represent a transition from an opening shape to a polyangular cross-section. The polyangular cross-section may, for example, contribute to turbulence as the container is shaken. This turbulence may, for example, aid in the mixing process.

In this example, the cross-sectional area continues to expand to the largest polyangular cross-section 106. This section may, for example, be positioned to increase turbulence. The largest polyangular cross-section 106 may, for example, create a focal point for radial turbulence. This may, for example, enhance the mixing of contents.

Following the largest polyangular cross-section 106, a third polyangular cross-section 108 is illustrated. As shown, this section continues to follow a helical spiral of the polyangular facets. The third polyangular cross-section 108 may, for example, continue to induce rotational turbulence 120c.

At the bottom of the container, a terminal end cross-section 112 is shown. This section may, for example, be designed to induce longitudinally reversing and/or radially outward flow. In some embodiments, the polyangular cross-sections may continue. In some embodiments, the polyangular cross-sections may transition to a circular cross-section, for example.

Some embodiments of the multi-axial turbulence induction container may, for example, include polyangular cross sections with eight or more facets. The inclusion of eight or more facets may, for example, enhance the washability of the container. Enhanced washability may, for example, result from reducing the accumulation of residues in the interior volume. In some examples, the number of facets may exceed twelve. Having more than twelve facets may, for example, reduce the efficacy of inducing rotational turbulence within the container. This reduction in efficacy may occur because the increased number of facets may, for example, lead to a smoother interior surface. A smoother interior surface may, for example, decrease the turbulence generated during the shaking process.

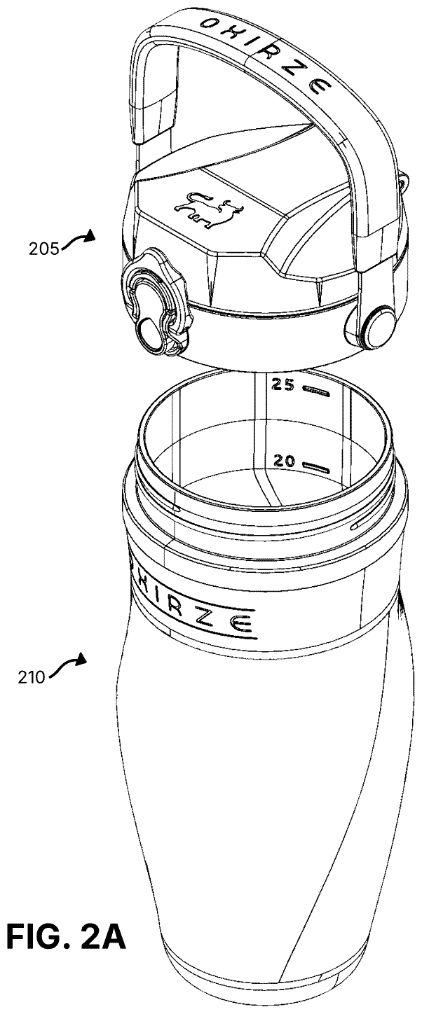

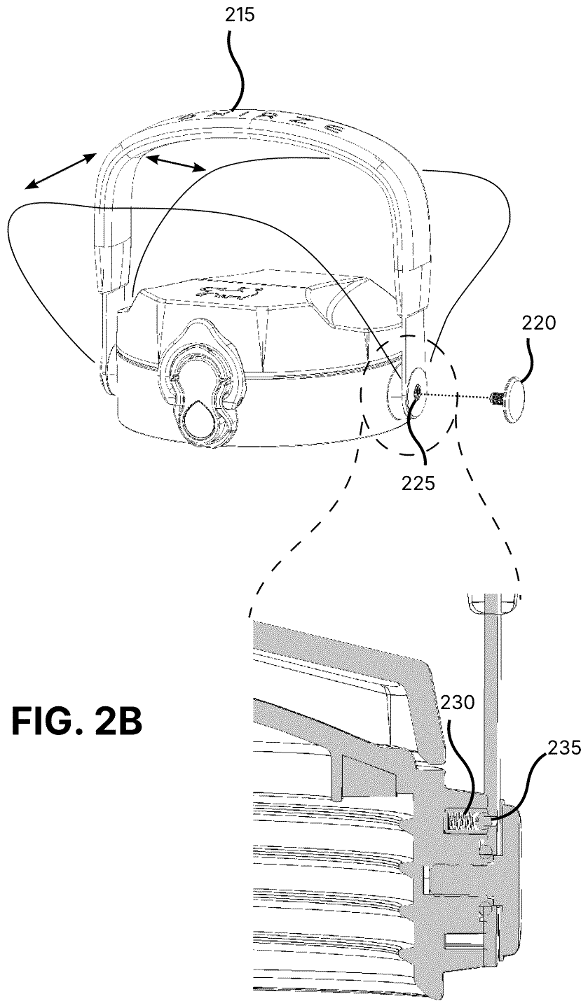

FIGS. 2A-2B depict an exemplary multi-axial turbulence induction container 110. The exemplary multi-axial turbulence induction container 110 includes a cap 205. The exemplary multi-axial turbulence induction container 110 includes a bottle 210. The exemplary multi-axial turbulence induction container 110 includes a handle 215. The handle may, for example, include a hinge 220. The handle may, for example, include predetermined placements. The handle may, as shown in this example, include an urging member 230 and a locking member 235 (e.g., detent locking member as shown). The handle may, for example, as shown, include an aperture 225 configured to receive the hinge 220.

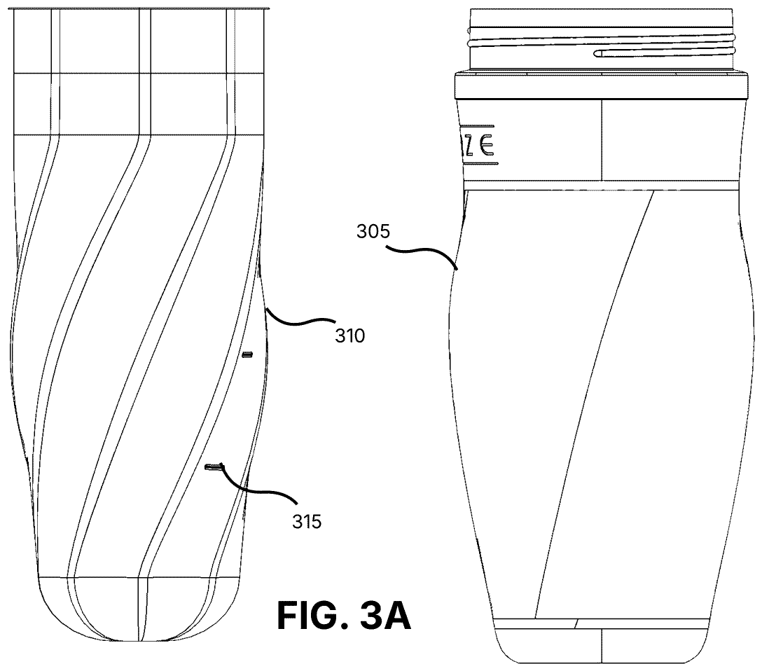

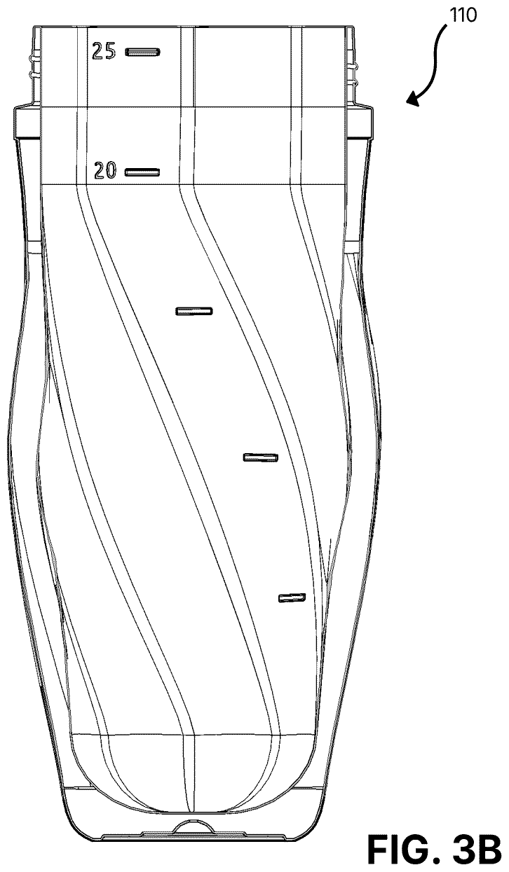

Turning to FIG. 3A, the illustration depicts a side view of an exploded container structure. The outer wall 305 is shown. The outer wall 305 may provide the external surface of the container. Adjacent to the outer wall 305, the inner wall 310 is depicted. The inner wall 310 may define the internal boundary of the container.

In some embodiments, such as depicted the outer wall may follow the helical shape of the inner wall. This configuration may, for example, enhance the aesthetic appeal of the container.

In some embodiments, the outer wall may be a different shape, such as non-faceted. A non-faceted outer wall may, for example, provide a smoother surface which may, for example, advantageously facilitate easier cleaning.

In some embodiments, the inner and outer walls may be unitarily formed. This unitary formation may, for example, improve the structural integrity of the container.

In some embodiments, the inner and outer walls may be separate components assembled together. Assembling separate components may, for example, allow for easier customization of materials and/or finishes for each wall.

Indicia 315 are present on the surface. The indicia 315 may serve to provide information and/or measurement markings. The indicia 315 may facilitate user interaction by providing visual cues or measurements.

FIG. 3B shows a longitudinal cross-sectional view of the container 110. The container 110 is depicted with a series of markings. The markings may correspond to volume measurements. The design of the container 110 may, for example, facilitate easy handling and pouring. The indicia 315 on the container 110 may assist in accurately measuring the contents within. The container 110, as shown, may be used in various applications where precise measurement and handling are beneficial.

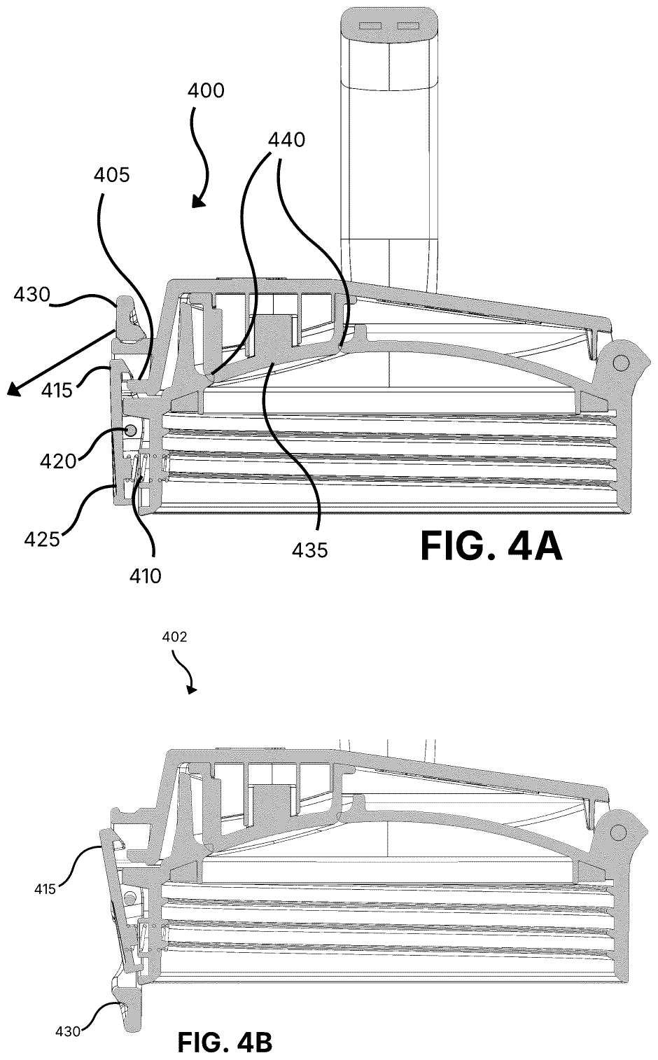

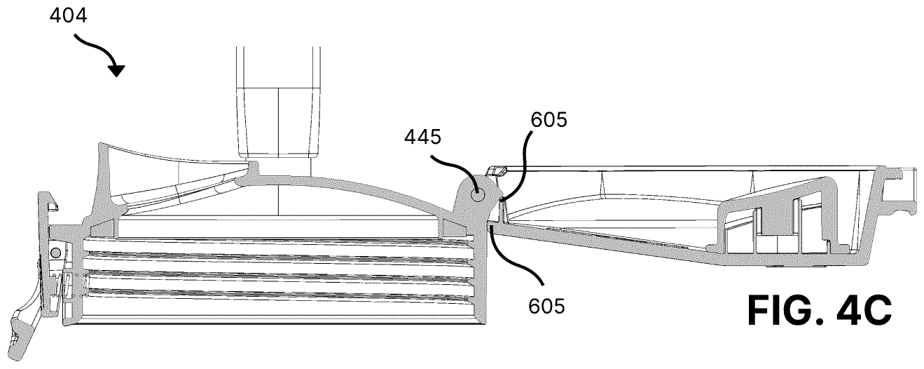

Turning to FIG. 4A, the figure illustrates the cap 205 in a closed mode 400. A retention member 405 is shown engaged by the latching member 415. The latching member 415 includes a release member 425. Operation of the release member 425 induces rotation of the latching member 415 about a hinge 420 (e.g., allowing for disengagement from the retention member 405). An urging member 410, in this example, biases the latching member 415 towards a latched position.

The cap 205 includes an engagement switch 430. The engagement switch 430 may rotate upwards over the retention member 405 of the lid. Accordingly, even if the release member 425 is operated to release the latching member 415, the engagement switch 430 may hold the lid in the closed mode 400. This may, for example, advantageously reduce accidental opening and/or spillage.

In this example, the cap 205 includes a sealing member 435. The sealing member 435 may sealingly engage a sealing region 440. The sealing region 440 may, for example, be a boundary of an opening in the cap. When the lid is in the closed position, the sealing member 435 may engage the sealing region 440. As a result, an opening into the interior volume of the container may be selectively fluidly sealed. This may, for example, create a closed volume within the container.

In some embodiments, the sealing member 435 may be unitarily formed as part of the cap structure. This configuration may, for example, provide a seamless integration. Seamless integration may, for example, reduce the risk of leaks.

Some embodiments may include a sealing member 435 that is a separate component attached to the cap. This separable design may, for example, facilitate easy replacement. Easy replacement may, for example, aid in maintenance.

In some embodiments, the sealing member 435 may be replaceable. Replaceable sealing members may, for example, allow users to replace worn or damaged seals. Replacing worn or damaged seals may, for example, extend the lifespan of the container.

Some embodiments may include a sealing member 435 constructed from silicone material. Silicone may, for example, offer flexibility. Flexibility may, for example, enhance the sealing performance. Silicone may, for example, provide durability. Durability may, for example, further enhance the sealing performance.

In some embodiments, the sealing member 435 may be made from flexible materials, such as elastomeric compounds. Elastomeric compounds may, for example, provide flexibility. Flexibility may, for example, enhance sealing capability. Elastomeric compounds may, for example, offer sealing capability.

Some embodiments may include a sealing member 435 that is foodsafe. Foodsafe characteristics may, for example, facilitate suitability for use with consumable liquids. Suitability for use with consumable liquids may, for example, maintain safety standards. Foodsafe characteristics may, for example, maintain hygiene standards.

FIG. 4B depicts the device in an unlatched mode 402. The latching member 415 is shown in a disengaged state. The engagement switch 430 is positioned to facilitate the transition to the unlatched mode 402. This configuration may allow for easy access to the interior components of the device.

FIG. 4C illustrates the device in an open position 404, opening about a hinge 445. The cap 205 is provided with interference members 605, as depicted at in this example at two locations. These members may, for example, prevent overextension.

The open position 404 may, for example, provide selective fluid access into the container 110. For example, the open position 404 may permit drinking of contents of the container 110.

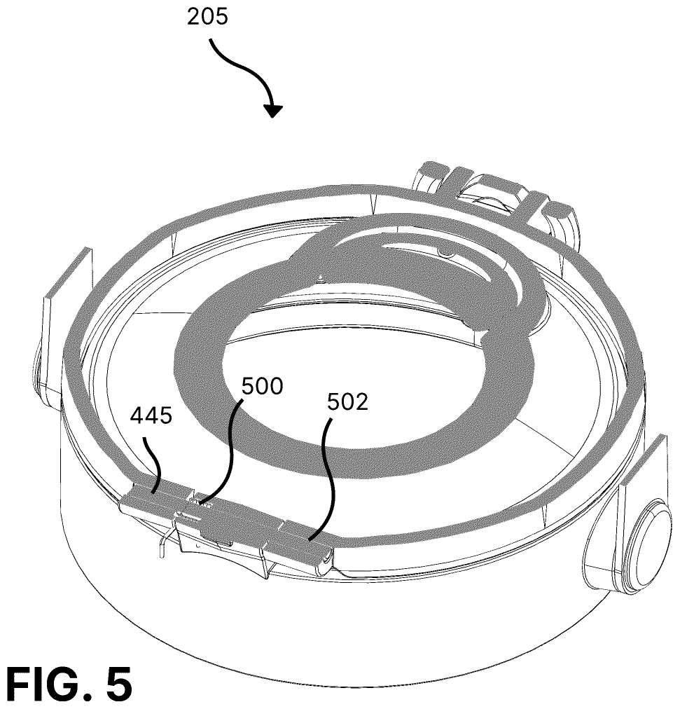

FIG. 5 depicts an exemplary illustrative use-case scenario including a hinge of an exemplary multi-axial turbulence induction container lid. The cap 205 is depicted in the figure. The cap 205 includes a hinge 445. The hinge 445 may facilitate the opening and closing of the cap 205. The hinge 445 is connected to an urging member 500. The urging member 500 may, for example, provide a force urging the cap 205 into an open closed position.

The hinge 220 member is fitted into the cap 205 with a friction fit 502. The friction fit 502 may, for example, facilitate a secure closure of the cap 205. In some embodiments, for example, damping material may, for example, be added between a rotating pin and the lid. The friction fit 502 and/or damping material may, for example, reduce the speed of the lid movement when it is opened. This may advantageously control the lid's movement.

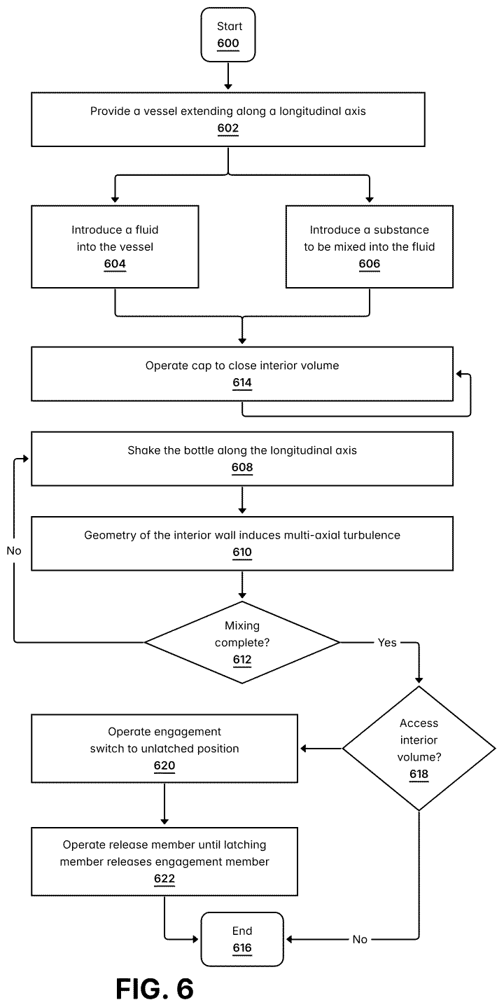

FIG. 6 shows a flowchart illustrating a method for using a multi-axial turbulence induction container. The process begins at step 600. At step 602, a vessel extending along a longitudinal axis is provided. This vessel is configured to facilitate the mixing process.

At step 604, a fluid is introduced into the vessel. In some examples, this fluid may include water. At step 606, a substance to be mixed into the fluid is introduced. This substance may, for example, include protein powder.

Following the introduction of the fluid and substance, step 614 involves operating the cap to close the interior volume. This may, for example, securely contain the contents within the vessel. At step 608, the bottle is shaken along the longitudinal axis. This action is designed to initiate the mixing process.

At step 610, the geometry of the interior wall induces multi-axial turbulence. This turbulence facilitates the thorough mixing of the fluid and substance. Step 612 determines if the mixing is complete. If not, the process may return to step 608 for further shaking.

If mixing is complete, the process proceeds to step 618, where it is determined if the interior volume is to be accessed. If yes, step 620 involves operating an engagement switch 430 to an unlatched position. At step 622, a release member 425 is operated until a latching member 415 releases the retention member 405. The process concludes at step 616.

Appendixes A, B, and D depict some exemplary drawings of an exemplary multi-axial turbulence induction container. Appendix C depicts some exemplary multi-turbulence induction container embodiments, and exemplary markings of structural features. Appendix E depicts some exemplary multi-turbulence induction container schematics and embodiments. Appendix E depicts the exemplary ball configuration hinge in connection to the cap and handle. The ball connection may, for example, advantageously prevent the handle from rotating back and forth rapidly as a user is shaking the shaker. The ball connection may, for example, lock-in-the handle to a predetermined selection of areas, until a user changes the position of the handle.

Although various embodiments have been described with reference to the figures, other embodiments are possible.

Although an exemplary system has been described with reference to FIGS. 1-5 and Appendixes A-E, other implementations may be deployed in other industrial, scientific, medical, commercial, and/or residential applications.

In industrial applications, the multi-axial turbulence induction container may, for example, be used in the production of fitness supplements. Precise mixing of protein powders and nutritional additives may, for example, be beneficial in such applications. The multi-axial turbulence induction container may, for example, be integrated into the manufacturing process of pre-workout drinks. This integration may, for example, facilitate even distribution of ingredients to maintain product consistency. Multi-axial turbulence induction containers may, for example, be employed in the production of energy drinks. The multi-axial turbulence induction container may, for example, assist in the preparation of meal replacement shakes on an industrial scale. This assistance may, for example, make it easier to deliver balanced nutrition to fitness enthusiasts. The multi-axial turbulence induction container may, for example, be deployed in the manufacturing of hydration supplements.

In scientific applications, multi-axial turbulence induction containers may, for example, be used in research laboratories. These containers may, for example, be used to develop new fitness supplements that benefit from precise blending of experimental ingredients. The multi-axial turbulence induction container may, for example, be employed in studies focusing on the efficacy of various protein powders. These studies may, for example, assess the ability of protein powders to mix thoroughly without clumping. The multi-axial turbulence induction container may, for example, assist in the research and development of new workout supplements. This assistance may, for example, facilitate even mixing of experimental compounds for accurate testing.

In medical applications, the multi-axial turbulence induction container may, for example, be used in the preparation of specialized nutrition drinks for patients recovering from surgery or illness. The multi-axial turbulence induction container may, for example, be utilized in sports medicine clinics. These clinics may, for example, prepare supplements that aid in muscle recovery and rehabilitation. The multi-axial turbulence induction container may, for example, be applied in the formulation of high-calorie shakes for patients needing to gain weight. This application may, for example, facilitate a smooth and palatable blend. The multi-axial turbulence induction container may, for example, be employed in the creation of electrolyte solutions for dehydration treatment in athletes. This employment may, for example, facilitate even distribution of salts and sugars. The multi-axial turbulence induction container may, for example, be useful in the preparation of balanced meal replacement drinks for patients with specific dietary needs.

In commercial applications, the multi-axial turbulence induction container may, for example, be integrated into home fitness products. This integration may, for example, offer consumers a convenient and effective way to mix their workout drinks before or after exercise. The multi-axial turbulence induction container may, for example, be utilized in wellness programs. These programs may, for example, provide participants with custom nutrition solutions. The multi-axial turbulence induction container may, for example, be part of a high-end line of fitness products.

In residential applications, multi-axial turbulence induction containers may, for example, be used by fitness enthusiasts at home. These containers may, for example, be used to prepare daily protein shakes. The multi-axial turbulence induction container may, for example, be employed in the kitchen to prepare meal replacement shakes. The multi-axial turbulence induction container may, for example, be part of a daily routine for individuals focused on health and wellness. This routine may, for example, provide a reliable way to prepare smoothies and other nutrient-dense drinks. The multi-axial turbulence induction container may, for example, be used by athletes and active individuals to prepare hydration drinks before heading out for a run or workout. The multi-axial turbulence induction container may, for example, be featured in personal training sessions conducted at home.

In educational applications, the multi-axial turbulence induction container may, for example, be used in health and fitness classes. These classes may, for example, demonstrate the importance of proper mixing techniques for supplements and nutrition drinks. The multi-axial turbulence induction container may, for example, be included in classroom labs. These labs may, for example, allow students to learn about the chemistry of mixing powders and liquids, with a focus on fitness and sports nutrition. The multi-axial turbulence induction container may, for example, be employed in vocational training programs for personal trainers and fitness coaches. These programs may, for example, teach them how to use tools for preparing client supplements. The multi-axial turbulence induction container may, for example, be featured in instructional videos for home fitness enthusiasts. These videos may, for example, teach them how to prepare their supplements and nutrition drinks using professional-grade equipment.

In some examples, the multi-axial turbulence induction container may be used to mix meal replacement powders with water. The turbulence induced by the container may, for example, facilitate the thorough blending of the meal replacement powder, resulting in a smooth and consistent mixture.

In some embodiments, the container may be employed to mix powdered drink mixes, such as electrolyte powders, with water. The multi-axial turbulence may, for example, facilitate even distribution of the electrolyte powder, enhancing the hydration properties of the resulting beverage.

Some examples may include the use of the container to blend powdered supplements, such as creatine or branched-chain amino acids (BCAAs), with a liquid. The turbulence generated within the container may, for example, aid in dissolving the supplements, providing a homogenous solution for consumption.

In some embodiments, the container may be utilized to mix powdered coffee or tea with hot water. The multi-axial turbulence may, for example, assist in dissolving the powder, creating a well-mixed and flavorful beverage.

In some examples, the container 110 may be used to mix powdered milk with water. In various embodiments, the container 110 may be utilized to mix baby formula with water. The multi-axial turbulence may, for example, help to dissolve the powdered milk. In some examples, the turbulence may assist in dissolving the baby formula. This may result in a smooth and creamy liquid suitable for drinking or cooking.

In some examples, the multi-axial turbulence induction container may be used to mix cleaning solutions with water. The turbulence induced by the container may, for example, facilitate the thorough blending of cleaning agents, resulting in a uniform cleaning solution.

In some embodiments, the container may be employed to mix laboratory samples, such as chemical reagents, with a solvent. The multi-axial turbulence may, for example, facilitate even distribution of the reagents, enhancing the accuracy of experimental results.

Some examples may include the use of the container to blend medicinal agents with a liquid carrier. The turbulence generated within the container may, for example, aid in dissolving the medicinal compounds, providing a homogenous solution for administration.

In some embodiments, the container may be utilized to mix substances (e.g., acids, solvents) for industrial applications. The multi-axial turbulence may, for example, assist in the safe and controlled dilution of acids, creating a well-mixed and stable solution.

In an illustrative example, the multi-axial turbulence induction container may, for example, include a bottle. The multi-axial turbulence induction container may include a cap. The multi-axial turbulence induction container may include an 18/8 polished taper on the bottle for the lid. The multi-axial turbulence induction container may include a silk etching on the bottle. The multi-axial turbulence induction container may include powder coating for the bottle. The multi-axial turbulence induction container may include a silicone sleeve for the bottle. The multi-axial turbulence induction container may include an outer layer with a message etched on the bottle. The multi-axial turbulence induction container may include a silicone sleeve with a twisted inner layer. The multi-axial turbulence induction container may include a silicone sleeve with an inner layer measurement scale. The multi-axial turbulence induction container may include a silicone sleeve configured for stable standing. The multi-axial turbulence induction container may include a silicone sleeve with an outer coated layer.

The multi-axial turbulence induction container may, for example, be shaken up and down along a predetermined axis. The multi-axial turbulence induction container may, for example, include a fluid, such as water, and a powder, such as protein powder. The sleeve's shape contours may, for example, facilitate turbulence. The turbulence may, for example, be used to mix the protein powder and water together.

Various embodiments may achieve one or more advantages. For example, some embodiments may include a bottle designed for protein mixing with integrated hot and cold insulation. Some embodiments may be capable of maintaining contents hot for 12 hours. Some embodiments may be capable of maintaining contents cold for 24 hours. Some embodiments may, for example, be capable of maintaining ice for 2 days at room temperature.

Some embodiments may, for example, include a bottle that has a capacity of more than 26 oz (769 ml). Some bottle embodiments may, for example, be constructed from double-wall 18/8 stainless steel. Some embodiments may, for example, include exterior features including a powder coating with logo laser etching. In some embodiments, the interior may, for example, be etched with measuring marks.

Some embodiments may, for example, reduce or avoid use of a shaker ball, such as by combining mixing and drinking functions into one unit. Some embodiments include a waterproof cap. The cap may, for example, be designed without internal blockages to facilitate smooth water flow. The cap may, for example, include a handle for easy lifting.

In some embodiments, the bottle may, for example, be odor-free. In some embodiments, the bottle may, for example, be BPA-free. In some embodiments, the bottle may, for example, be toxin-free. In some embodiments, the bottle may, for example, be powder coated. In some embodiments, the bottle may, for example, fit into standard car cup holders. In some embodiments, the bottle may, for example, be dishwasher safe.

Some embodiments may, for example, include a bottle structure including a twisted body. Some embodiments may, for example, include a plastic cap with a metal insert handle. Some embodiments may, for example, provide a flip lid that opens when the lock is released. Some embodiments may, for example, include messages, such as brand logos, printed on both the cap and/or the bottle body.

Some embodiments may, for example, include a silicone sleeve. The silicone sleeve may, for example, be installed on the bottle's bottom via interference fitting. The bottle may, for example, include an octagon twisted shape to enhance blending performance. In some embodiments, the interference fitting between the fixing pin and the cap base and/or between the sealing cap and spout may, for example, be designed to be adjustable. The adjustability of the interference fitting may, for example, facilitate waterproof performance in both hot and cold conditions. In some embodiments, the lid movement may, for example, be slowed when opening, either by maintaining certain interference and/or by adding damping material between the rotating pin and the lid. In some embodiments, friction may, for example, prevent the lid from opening when the button is fully pressed.

In some embodiments, a multi-axial turbulence induction container may include a pump dispenser. The pump dispenser may, for example, allow for controlled dispensing of the container's contents.

Some embodiments may include a squeeze tube dispenser. The squeeze tube dispenser may, for example, facilitate easy and precise dispensing of viscous fluids.

In various embodiments, the multi-axial turbulence induction container may include a flip-top cap dispenser. The flip-top cap dispenser may, for example, provide quick access to the contents while maintaining a secure seal when closed.

In some examples, the multi-axial turbulence induction container may include a trigger spray dispenser. The trigger spray dispenser may, for example, enable the distribution of liquid contents in a fine mist.

Some embodiments may include a roller ball dispenser. The roller ball dispenser may, for example, be used for applying liquid contents evenly across a surface.

In certain embodiments, the multi-axial turbulence induction container may include a shaker dispenser. The shaker dispenser may, for example, allow for the distribution of powdered or granular contents through a sieve-like mechanism.

As an illustrative example, a multi-axial turbulence induction container may include a handheld drinking vessel. The vessel may extend along a longitudinal axis from an opening to a terminal end. The vessel may have an interior volume defined by an interior wall. The interior wall may have a geometry with a series of polyangular cross sections orthogonal to the longitudinal axis. The largest polyangular cross section may be located between the opening and the terminal end. The curvature of the interior wall may have a single inflection point before and after the largest polyangular cross section. Adjacent polyangular cross sections may be rotated relative to each other along a helical path. Each angle in the polyangular cross sections may be obtuse. The bottom of the interior wall may be convex. A cap may be configured to seal over the opening, creating a fluidly sealed space. The geometry of the interior wall may induce multi-axial turbulence, including rotational flow around the longitudinal axis, turbulence around the largest polyangular cross-section, and longitudinally reversing and radially outward flow at the bottom of the interior volume.

In some examples, the cap may include a handle. The cap may have an urging member. The cap may have a detent locking member urged by the urging member to resist rotation of the handle relative to the cap in any of several predetermined handle positions.

In some examples, the container may have a separate base attached to the bottom of the exterior wall of the vessel.

As an illustrative example, a container may include a vessel extending along a longitudinal axis from an opening to a terminal end. The vessel may have an interior volume defined by an interior wall. The interior wall may have a geometry with a series of polyangular cross sections orthogonal to the longitudinal axis. The largest polyangular cross section may be located between the opening and the terminal end. The curvature of the interior wall may have a first inflection point before and a second inflection point after the largest polyangular cross section. Adjacent polyangular cross sections may be rotated relative to each other along a helical path.

In some examples, the geometry of the interior wall may induce multi-axial turbulence, including rotational flow around the longitudinal axis and turbulence induced by the largest polyangular cross section.

In some examples, the largest polyangular cross section may be located in the middle half of the interior volume relative to the longitudinal axis.

In some examples, the largest polyangular cross section may be located in the middle third of the interior volume relative to the longitudinal axis.

In some examples, the first inflection point may be the only inflection point before the largest polyangular cross section.

In some examples, the second inflection point may be the only inflection point after the largest polyangular cross section.

In some examples, the interior wall may be symmetric about the longitudinal axis.

In some examples, the bottom of the interior wall, defining the bottom of the interior volume, may be convex.

In some examples, the convex bottom of the interior wall may induce longitudinally reversing and radially outward flow at the bottom of the interior volume.

In some examples, a cap may be configured to seal over the opening, creating a fluidly sealed space.

In some examples, the cap may include a handle. The cap may have an urging member. The cap may have a detent locking member urged by the urging member to resist rotation of the handle relative to the cap in any of several predetermined handle positions.

In some examples, the outer wall of the vessel may follow the contour of the interior wall except at the bottom of the vessel, where the outer wall may define a flat resting surface in a plane intersecting the longitudinal axis.

In some examples, the container may have a separate base attached to the outer wall at least at the bottom of the vessel.

In some examples, the vessel may be configured as a handheld drinking container.

As an illustrative example, a method may include providing a vessel extending along a longitudinal axis from an opening to a terminal end. The vessel may have an interior volume defined by an interior wall. The interior wall may have a geometry with a series of polyangular cross sections orthogonal to the longitudinal axis. The largest polyangular cross section may be located between the opening and the terminal end. The curvature of the interior wall may have an inflection point before and after the largest polyangular cross section. Adjacent polyangular cross sections may be rotated relative to each other along a helical path. The method may include introducing a fluid and a substance to be mixed into the fluid into the vessel. The method may include shaking the bottle along the longitudinal axis such that the geometry of the interior wall induces multi-axial turbulence in the fluid, mixing the substance into the fluid.

In some examples, the substance may be mixed into the fluid without protrusions into at least one half of the interior volume along the longitudinal axis.

In some examples, the substance may be mixed into the fluid solely by fluid flow induced by a wall bounding the interior volume and including the interior wall of the vessel.

In some examples, the vessel may have a curved bottom configured to contribute to inducing the multi-axial turbulence.

It will be understood that various modifications can be made within the scope of this disclosure. Embodiments depict illustrative combinations of disclosed features, components, and/or steps. Any combination of disclosed features is expressly contemplated unless specifically excluded or required by the context. For example, one or more advantageously results may be achieved if components are removed, added, multiplied, scaled, and/or rearranged, and/or if steps in a method are omitted, added, repeated, and/or performed in a different order. Therefore, other implementations are contemplated.

1. A multi-axial turbulence induction container comprising:
a vessel, configured for handheld drinking use, extending along a longitudinal axis from an opening into the vessel to a terminal end of the vessel, the vessel comprising an interior volume defined by an interior wall of the vessel, wherein:
the interior wall comprises a geometry comprising a series of polyangular cross sections orthogonal to the longitudinal axis, wherein:
a largest polyangular cross section is between the opening and the terminal end,
a curvature of the interior wall with reference to the longitudinal axis comprises a single inflection point before the largest polyangular cross section and a single inflection point after the largest polyangular cross section,
adjacent polyangular cross sections are rotated relative to each other about the longitudinal axis and along a helical path, and
each angle in the polyangular cross sections is an obtuse angle, and
a bottom of the interior wall, defining a bottom of the interior volume, is convex; and
a cap configured to sealingly couple over the opening such that the interior volume defines a fluidly sealed space,
wherein the geometry is configured such that it induces multi-axial turbulence comprising:
rotational flow around the longitudinal axis,
turbulence around the largest polyangular cross section, and
longitudinally reversing and radially outward flow at the bottom of the interior volume.

2. The multi-axial turbulence induction container of claim 1, wherein the cap comprises:
a handle;
an urging member, and
a detent locking member urged by the urging member to resist rotation of the handle, relative to the cap, when in any of a plurality of predetermined handle positions.

3. The multi-axial turbulence induction container of claim 1, further comprising a separate base coupled to a bottom of an exterior wall of the vessel.

4. A container comprising:
a vessel extending along a longitudinal axis from an opening into the vessel to a terminal end of the vessel, the vessel comprising an interior volume defined by an interior wall of the vessel, wherein:
the interior wall comprises a geometry comprising a series of polyangular cross sections orthogonal to the longitudinal axis, wherein:
a largest polyangular cross section is between the opening and the terminal end,
a curvature of the interior wall with reference to the longitudinal axis comprises a first inflection point before the largest polyangular cross section and a second inflection point after the largest polyangular cross section, and
adjacent polyangular cross sections are rotated relative to each other about the longitudinal axis and along a helical path.

5. The container of claim 4 wherein the geometry is configured such that it induces multi- axial turbulence comprising:
rotational flow around the longitudinal axis, and
turbulence induced by the largest polyangular cross section.

6. The container of claim 4, wherein the largest polyangular cross section is disposed in a middle half of the interior volume, relative to the longitudinal axis.

7. The container of claim 6, wherein the largest polyangular cross section is disposed in a middle third of the interior volume, relative to the longitudinal axis.

8. The container of claim 4, wherein the first inflection point is a sole inflection point before the largest polyangular cross section.

9. The container of claim 4, wherein the second inflection point is a sole inflection point after the largest polyangular cross section.

10. The container of claim 4, wherein the interior wall is symmetric about the longitudinal axis.

11. The container of claim 4, wherein a bottom of the interior wall, defining a bottom of the interior volume, is convex.

12. The container of claim 11, wherein the bottom of the interior wall is configured to induce longitudinally reversing and radially outward flow at the bottom of the interior volume.

13. The container of claim 4, comprising a cap configured to sealingly couple over the opening such that the interior volume defines a fluidly sealed space.

14. The container of claim 13, wherein the cap comprises:
a handle;
an urging member; and
a detent locking member urged by the urging member to resist rotation of the handle, relative to the cap, when in any of a plurality of predetermined handle positions.

15. The container of claim 4, wherein an outer wall of the vessel follows a contour of the interior wall except at a bottom of the vessel, where the outer wall defines a flat resting surface in a plane intersecting the longitudinal axis.

16. The container of claim 15, further comprising a separate base coupled to the outer wall at least at a bottom of the vessel.

17. The container of claim 4, wherein the vessel is configured as a handheld drinking container.

18. A method comprising:
providing a vessel, extending along a longitudinal axis from an opening into the vessel to a terminal end of the vessel, the vessel comprising an interior volume defined by an interior wall of the vessel, wherein:
the interior wall comprises a geometry comprising a series of polyangular cross sections orthogonal to the longitudinal axis, wherein:
a largest polyangular cross section is between the opening and the terminal end,
a curvature of the interior wall with reference to the longitudinal axis comprises an inflection point before the largest polyangular cross section and an inflection point after the largest polyangular cross section, and
adjacent polyangular cross sections are rotated relative to each other about the longitudinal axis and along a helical path;
introducing into the vessel:
a fluid; and
a substance to be mixed into the fluid; and
shaking the vessel along the longitudinal axis such that the geometry induces multi-axial turbulence in the fluid such that the substance is mixed into the fluid.

19. The method of claim 18, wherein the substance is mixed into the fluid without protrusions into at least one half of the interior volume and along the longitudinal axis.

20. The method of claim 19, wherein the substance is mixed into the fluid solely by fluid flow induced by a wall bounding the interior volume and comprising the interior wall of the vessel.

21. The method of claim 18, wherein the vessel comprises a curved bottom configured such that it contributes to induce the multi-axial turbulence.

22. A handheld drinking vessel extending along a longitudinal axis from a drinking opening to a terminal end, the handheld drinking vessel defining an interior volume and comprising means for inducing multi-axial turbulence, wherein:
the multi-axial turbulence comprises:
rotational flow around the longitudinal axis,
turbulence around a largest cross-section, relative to the longitudinal axis, of the interior volume, and
longitudinally reversing and radially outward flow at a bottom of the interior volume, and
the means for inducing multi-axial turbulence is configured to generate the multi-axial turbulence by a boundary of the interior volume.
